(19) United States
(12) Patent Application Publication
(10) Pub. No.: US 2007/0172297 A1
(43) Pub. Date: Jul. 26, 2007

(54) Input tray point of sale display (POS)

(76) Inventors: Michael Fujitani, Lakewood, CA (US); Darren Suess, Huntington Beach, CA (US); Robert Barrett, Long Beach, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/336,247

(22) Filed: Jan. 20, 2006

(51) Int. Cl. B41J 29/02

(52) U.S. Cl. 400/693

(57) ABSTRACT

A printer includes an input tray, a printer body, an output tray, and a point of sale display. Paper is fed through an input tray into the printer, the printer body disperses ink to form colors, text, or images, and the output tray of the printer receives the paper after ink has been dispersed on the paper. The point of sale display is attached to the input tray of the printer. A front panel, a pair of side panels, and a back panel of the point of sale display form an enclosure, where the enclosure has an opening therein, which is adapted to be placed over the input tray of the printer. The point of sale display has an image of a photograph or a recordable disk adhered to a front surface of the point of sale display.

### BACKGROUND OF THE INVENTION

1. Field of the Invention

The invention relates to printers and the utilization of point of sale advertising displays on printers.

2. Description of Related Art

In many computer and electronic retailer locations, a sample model of different computers and printers are displayed for the public to inspect and evaluate. In order to publicize the features of the printer, many retailers place a sign or placard next to the printer. In other locations, the retailers attach a sign or placard to a front of the shelf on which the printer rests. Printer manufacturers have also placed stickers directly on the printer to advertise features of the printer.

If the retailers place a sign or placard next to the printer, valuable shelf space is lost and a consumer's eyes may be pulled away from the printer product. If a sign or placard is placed in front of the shelf on which the printer rests, the size of the sign or placard may be limited because of the width of the shelf. If the sign or placard is large, it may obscure the view of the printer. If a printer manufacturer places stickers on the front of the printer, the printer manufacturer loses valuable space that may be utilized for different aspects of the printer. For example, many printers now have memory card readers on the front of the printer. In addition, in many printers, access to the paper feed path of the printer may be on a front panel of the printer. In some printer models, the output tray is on the front of the printer. Any sticker or advertising on the printer also has to be placed so that it does not impede or interfere with the paper feed path of the printer. A sticker or label may also be placed on a top surface of the printer. The sticker or label can detail the features of the printer. A disadvantage of placing a sticker or label on top of the printer is that this decreases an amount of space that can be utilized for a control panel of the printer, which is normally located on a top surface or side of the printer. In addition, the readability of the label is not as good as if a label is on the top surface because a consumer walking through the aisle would need to have the printer at around chest level in order to read the label when walking by. Alternatively, the consumer could step closer to the printer to read the label describing the features of the printer.

Accordingly, a need exists for a point of sale display for a printer that highlights at least one feature of the printer, does so in a clear fashion, presents a product printed by a printer similar to the one being utilized, is easily readable to the consumer, and does not interfere with a paper feed mechanism of the printer.

### BRIEF SUMMARY OF THE INVENTION

A point of sale (POS) display for a printer includes a front panel, a back panel, and a pair of side panels. The pair of side panels may be connected or connectable to a front panel and a back panel. The front panel includes a printable area. The front panel, back panel, and pair of side panels form an enclosure having an opening therein. The enclosure is attached to an input tray of the printer. The enclosure may fit over the input tray of the printer and does not interfere with a paper feed path of the printer. The printable area may includes indicia of features of the printer. In an embodiment of the invention, the front panel includes a printed image assembly attached to an outside surface of the front panel, wherein an image of the printed image assembly was printed by a photographic printer. In an embodiment of the invention, the front panel includes a recordable media having a printable surface attached to an outside surface of the front panel, wherein a label or an image was printed on the printable surface of the recordable media.

In an embodiment of the invention, the front panel, the back panel, and the pair of side panels are constructed of a single sheet of material which is foldable to form the POS display. The POS display may be adhered to a front surface of an input tray of the printer or may be adhered to a back surface of an input tray of the printer. The side panels of the POS display may include a locking tab to provide stability to the POS display when the locking tab is engaged. The locking tab may engage a slot to place the locking tab in a locked position, wherein the slot is located on a corner connecting the at least one of the pair of side panels to a back panel. In an embodiment of the invention, the back panel of the POS display may have a greater height than the front panel of the POS display.

### BRIEF DESCRIPTION OF THE DRAWINGS

FIG. 1 illustrates a front perspective view of a point of sale display and a printer according to an embodiment of the present invention;

FIG. 2(a) illustrates a front perspective view of a point of sale display including a actual photo print according to an embodiment of the invention;

FIG. 2(b) illustrates a front perspective view of a point of sale display including a recordable media attached to a point of sale display according to an embodiment of the present invention;

FIG. 3 illustrates a construction diagram of the point of sale display according to an embodiment of the present invention; and

FIG. 4 illustrates a method of making a point of sale display according to an embodiment of the present invention.

### DETAILED DESCRIPTION OF THE INVENTION

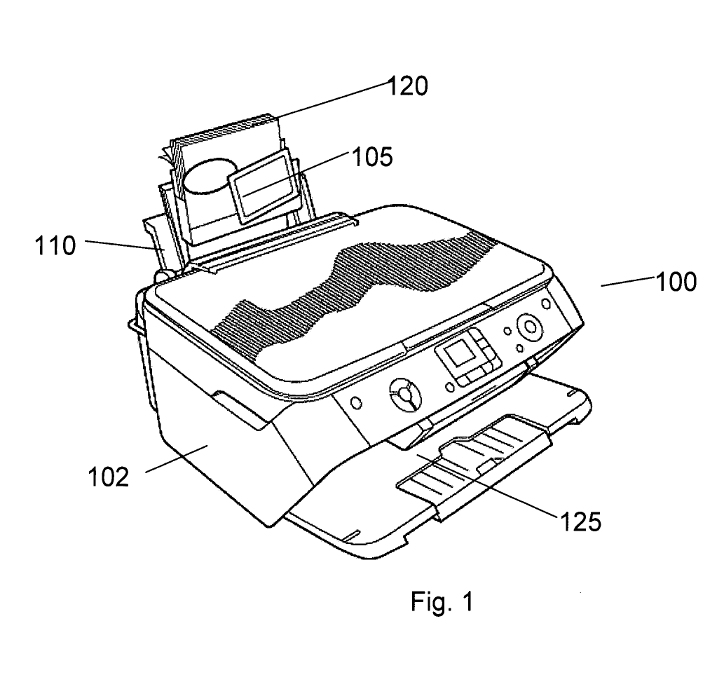

FIG. 1 illustrates a front perspective view of a point of sale display and a printer according to an embodiment of the present invention. The printer 100 is a printer that can be utilized for printing text documents, images, and labels. The printer may also be utilized to print onto a surface of recordable media, such as a compact disc and a digital video disc. The printer can be a model that generates prints of one or more of the following size documents, 5″ by 7″, 8.5″×11″, 8.5″ by 14″, A4, 11″×14″, and also wide format prints (up to 13″ in width). Illustratively, any of the Epson ink jet printers or the Epson all-in-one may be utilized as the printer for embodiments of this invention. In addition, a number of Epson wide format printers may also utilize the point of sale display, such as the Epson 1280 Printer, the R1800, and the R2400 printer. For example, in the wide format printers, the point of sale display may be utilized on printers printing a document having dimensions of 13″ wide by 19″ long. The printer 100 includes a main body 102, an output tray 125, and an input tray 110. In an embodiment of the present invention, the input tray 110 rises at an angle from a back section of the printer 100. For example, the input tray may be placed at an angle between 30 and 90 degrees from a horizontal planar surface, like the surface that the printer is resting on. The point of sale display 105 is removed from its packing material and is constructed into a rectangular-shaped box, where the point of sale display 105 has four sides and forms an opening which is interior to the four sides. The sides may also be referred to as sheets or panels. Accordingly, such terms may be utilized interchangeably herein. The back panel of the point of sale display 105 is attached to the input tray 110 of the printer 100. In an embodiment of the invention, an outside surface of the back panel of the point of sale display 105 is attached to a front surface of the input tray 110 of the printer. The opening of the interior of the point of sale display allows paper 120 to be inserted into the input tray 110 of the printer. The point of sale display 105 is aligned with the input tray 110 so that a back panel of the point of sale display 105 is parallel or coplanar with the input tray 110. The front panel of the point of sale display 105 is also parallel with the input tray 110. The point of sale display 105 does not interfere with the paper path of the printer 100. In other words, the paper 120 is not inhibited, by the point of sale display 105, from feeding from the input tray 110 into the printer 100 to the output tray of the printer 125.

In an embodiment of the invention, the back panel may be longer than the front panel of the point of sale display 105. This results in the indicia and/or images that are printed on a front side of the point of sale display 105 to be displayed at an optimum angle for consumer or user viewing. In this embodiment of the invention, a bottom surface of the front panel of the point of sale display 105 rests on, is directly above, or lies slightly above a top surface of the printer 100. This provides an optimum viewing angle for the point of sale display 105.

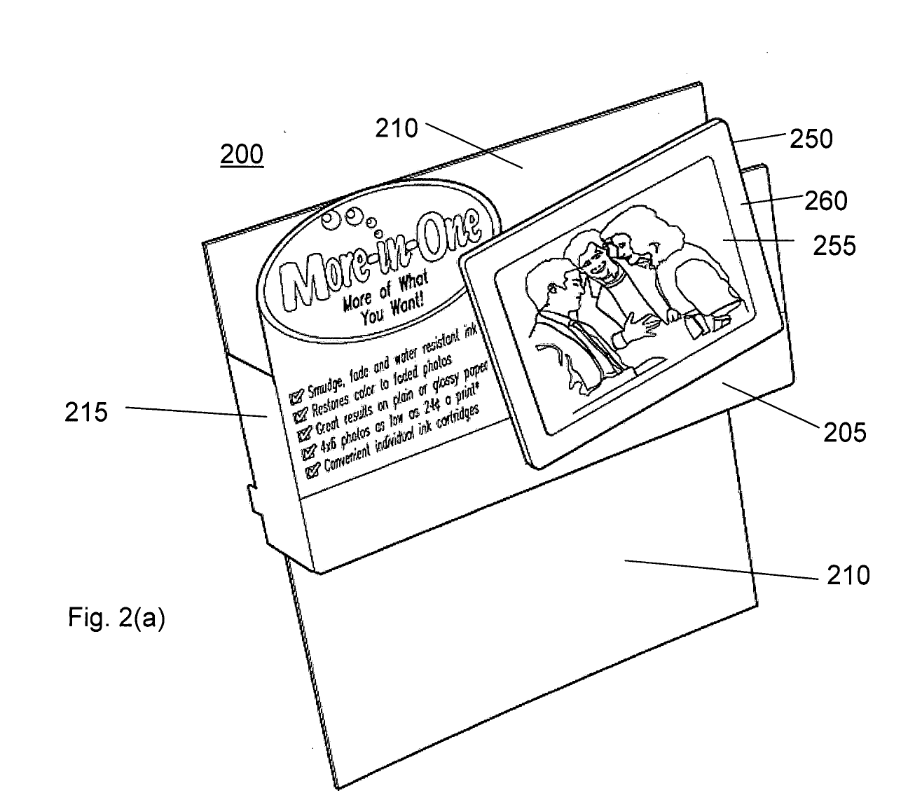

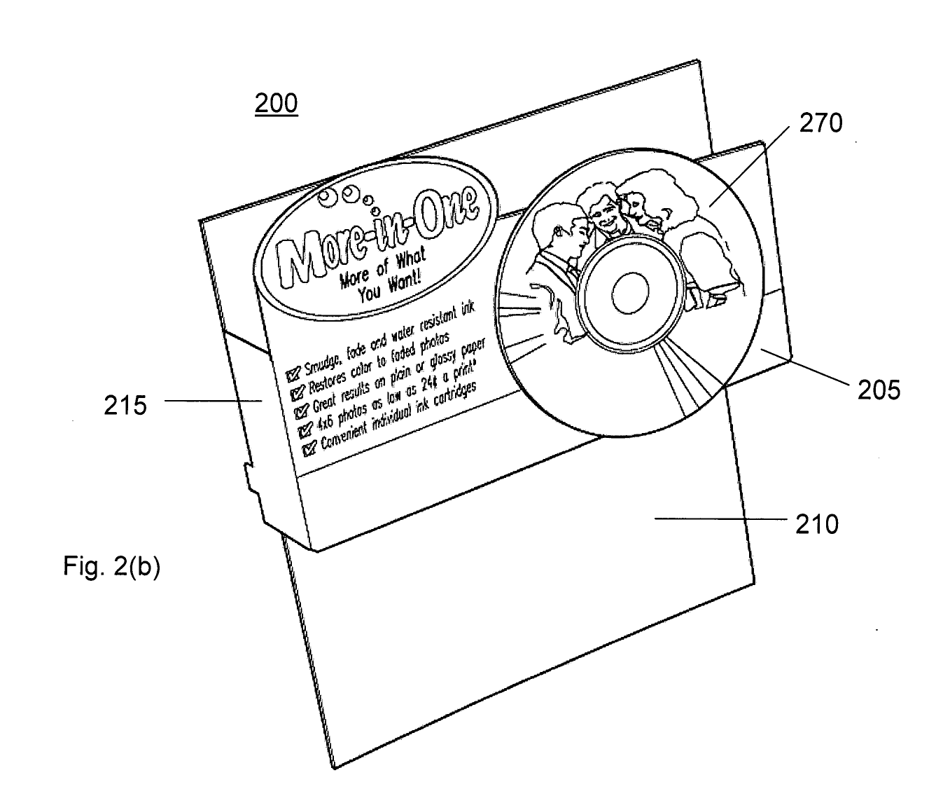

FIG. 2(a) illustrates a front perspective view of a point of sale display including a actual photo print according to an embodiment of the invention. The point of sale display 200 includes a front panel or sheet 205, a back panel 210, a first side panel 215, and a second side panel 220 (not illustrated in FIG. 2(a) or 2(b) due to the front perspective view). In an embodiment of the invention, the point of sale display 200 may be made out of E-flute cardboard or 24 pt card stock coated on one side.

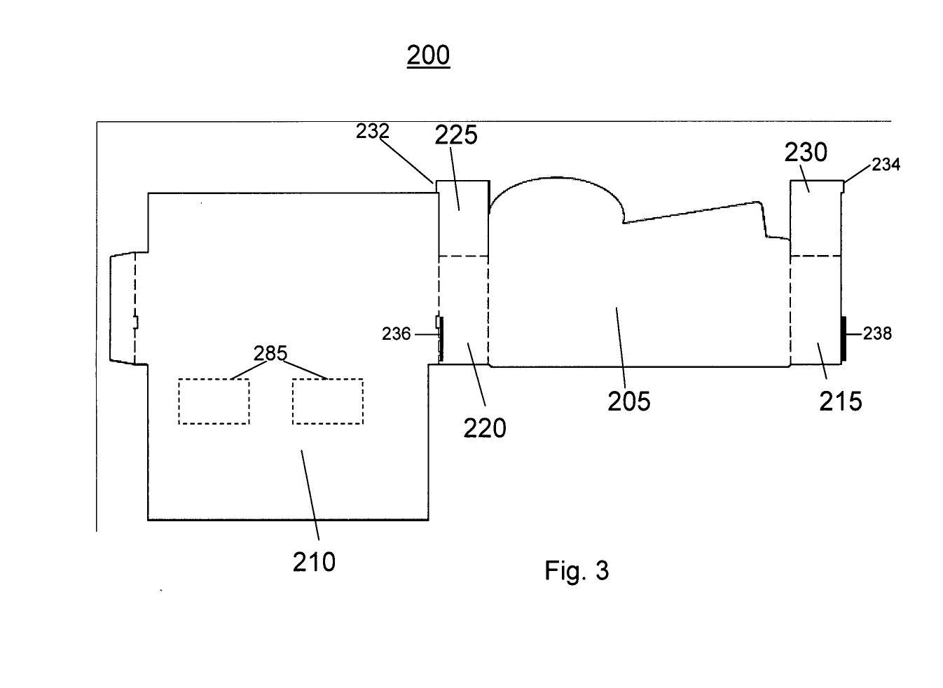

In an embodiment of the invention, the point of sale display 200 may have a one-piece construction. FIG. 3 illustrates a construction diagram of the point of sale display according to an embodiment of the present invention. In other words, the front panel 205 may be connected to the first side panel 215 and a second side panel 220 and the back panel 205 may be connected to the first side panel 215 and the second side panel 220. In manufacturing or constructing the point of sale display 200, one piece of material may be utilized and the material may be scored or cut in certain locations in order to provide the different flaps, locking tabs, or slots for the point of sale display 200. In an embodiment of the invention, one edge of one of the panels may not be connected to an adjacent edge. For example, one edge of the second side panel 220 may not be connected to the adjacent edge of the front panel 205. In this embodiment, the edges may be fastened or coupled together in order to create the point of sale display 200. In an embodiment of the invention, none of the front panel 205, back panel 210, first side panel 215, and second side panel 220 may be fastened or connected to each other. In this embodiment of the invention, a fastener or adhesive would be utilized to connect the front panel 205 to the first side panel 215 and the second side panel 220, and also to connect the back panel 210 to the first side panel 215 and the second side panel 220.

In an embodiment of the invention, the back panel or sheet 210 of the point of sale display 200 may have a greater height that the front panel or sheet 205 of the point of sale display. The greater height provides additional support for the point of sale display when the point of sale display 200 is installed on a paper support tray (or paper input tray) 110 (see FIG. 1) of the printer 100 (see FIG. 1).

An outside surface of each of the front panel 205, the back panel 210, the first side panel 215 and the second side panel 220 may have text, color, or image printing. For example, the outside surface of the front panel 205 may include a print(s) utilizing multiple colors, and also an area for text to describe features of the printer on which the point of sale display is mounted. If the point of sale display 200 is constructed of an E-flute cardboard, the text, color, or images may be first applied to a litho label, which is then applied to the E-flute cardboard. Under other operating conditions, a Flexographic printing process may be utilized to print the text, color, or images onto the E-flute cardboard. If the point of sale display is constructed of 24 pt. card stock, an offset lithography process may be utilized to print the text, color, or images onto the 24 pt. card stock.

The first side panel 215 and the second side panel 220 may also have printing such as a one color bar with an Epson slogan printed, e.g., “Epson—Exceed Your Vision.” In other embodiments of the invention, the first side panel 215 and the second side panel 220 may have a solid color printing or indicia identifying company names or product names. The outside surface of the back panel 210 may also include printable subject matter or indicia. For example, the outside surface of the back panel 210 may include legal information, product identification information, and/or product ordering information.

In an embodiment of the invention, the front panel 205 of the point of sale display 200 includes a printed image assembly 250 connected, adhered, or fastened to an outside surface of the front panel 205 of the point of sale display 200. In an embodiment of the invention, adhesive squares 285 (see FIG. 3) may be attached to the back of the printed image assembly 250 before connecting the printed image assembly 250 to the outside surface of the front panel 205 of the point of sale display 200. Before being connected, adhered, or fastened to the outside surface of the front panel 205, the printed image assembly 250 is constructed of a print of a photograph or image 255, a rectangular black foam support (not shown), and a frame 260. The rectangular foam support may be a pinched, black foam core. In an embodiment of the invention, the frame 260 may be constructed of a metallic paper. The frame 260 may be laminated on top of or the front of the rectangular foam support.

In an embodiment of the invention, the printed image assembly 250 includes a 3″×5″ image or print of the photograph. In an embodiment of the invention, the printed image assembly 250 includes a 4″ by 6″ image or print or the photograph. The printed image assembly may also include a 5″×7″ image or print of the photograph or an 8″ by 10″ image. The larger images may be utilized for point of sale displays 200 on the large or wide format printers. The image fastened to the front panel 205 of the point of sale display 200 is printed on a printer which is the same model or similar to the printer on which the point of sale display 200 is placed. FIG. 2(b) illustrates a recordable media attached to a point of sale display according to an embodiment of the present invention. In an embodiment of the invention, the front panel 205 of the point of sale display 200 includes a recordable media 270, which has a front surface that has been printed on, attached to an outside surface of the front panel 205 of the point of sale display 200. The recordable media 270 could be a compact disk, a digital video disk, or any other media having an exposed surface on which the printer 100 can print.

The point of sale display 200 may be stored in a flat package allowing the point of sale display to lie flat on a planar surface. The first side panel 215 and the second side panel or sheet 220 may bend at the corner that is attached to the back panel 210. The bending at the corner allows the front panel 205 of the point of sale display 200 to rest in a parallel plane with the back panel 210 of the point of sale display 200 during storage of the point of sale display. The front panel 205, when lying in a parallel plane to the back panel 210, is positioned to the right or to the left of the back panel 210 of the point of sale display. In other words, the width of the front panel 205 is not directly on top of the width of the back panel 210.

The point of sale display 205 may be opened. The first side panel 215 or the second side panel 220 may include locking tabs 225 and 230. In an embodiment of the invention, the locking tabs 225 and 230 may take up ⅓^{rd} of the height of the first side panel or sheet 215 or the second side panel or sheet 220. For example, if the first side panel 215 and the second side panel are six inches in height, the locking tabs 225 and 230 may be approximately two inches in height (or three inches and one inch, respectively). The locking tabs 225 and 230 include a notch 232 and 234 on an upper portion of the locking tab 225 and 230. In constructing the point of sale display 200 for the printer, the locking tabs 225 and 230 may be folded toward a center interior space in the point of sale display 205. This center space interior is open or hollow. In other words, there is no paper material in the center space of the point of sale display 205. The locking tables 225 and 230 may be folded towards each other, e.g., the first locking tab 225 may be folded towards the second side panel 215 and the second locking tab 230 may be folded towards the first side panel 220. The locking tabs 225 and 230 when folded may touch an inner surface of the side panels 215 or 220.

The locking tabs 225 and 230 may be folded approximately 180 degrees from the locking tabs 225 and 230 original position. In other embodiments of the invention, the locking tabs 225 and 230 may be folded between 90 and 270 degrees from the locking tabs' original position. The notches 232 and 234 on the locking tabs 225 and 230 fit into slots 236 and 238. By placing the notches 232 and 234 into the slots 236 and 238, the locking tabs 225 and 230 are locked in place and this provides additional stability, e.g., side-to-side stability, for the point of sale display 200. When the locking tab notches 232 and 234 are in the slots 236 and 248, the locking tabs 225 and 230 may be referred to as engaged. The slots 236 and 238 (or openings) may be located at corners of the point of sale display 200. The corners of the point of sale display 200 may be the corner formed by the back panel 210 with the first side panel 215 and with the second side panel 220. In an alternative embodiment of the invention, the corner of the point of sale display 200 may be the corners formed by the front panel 205 of the point of sale display 200 with the first side panel 210 and the second side panel 215.

The point of sale display 200 may form a rectangular box or an enclosure where a center section or space includes no material or paper. In other words, the center section is hollow. The box-shaped area is an open space to allow the point of sale display 200 to be utilized with a printer 100 without affecting or interfering with the paper feeding mechanism of the printer, e.g., the feeding of paper from the paper input tray 110 through the printer body 102 to the paper output tray 125. The enclosure does not interfere with an input paper feed path of the printer.

In an embodiment of the invention, an outside surface of the back panel 210 of the point of sale display may have connected to it or adhered to it one or a plurality of adhesives 285. The plurality of adhesives 285 may have a backing that is removable so that an adhesive surface remains once the back of the adhesive or plurality of adhesives 285 is removed. In other words, one side of the adhesive or plurality of adhesives 285 is adhered to or fastened to the outer surface of the back panel 210. The other side of the adhesive or plurality of adhesives 285 is connected to an input tray 110 (see FIG. 1) of the printer 100. In an embodiment of the invention, after the rectangular-shaped or boxed-shaped point of sale display 200 is formed, a backing is removed from one side of the adhesive or plurality of adhesives 255 in order for the adhesive(s) to be connected or adhered to the input tray.

As noted above, the adhesive or plurality of adhesives 285 is attached to the input tray 110 of the printer. The adhesive or plurality of adhesives 285 attach the point of sale display 200 to the input tray 110 of the printer 100 so that the point of sale display 200 does not interfere with paper feeding in the printer 100. After the point of sale display 200 has been installed on the input tray 110 of the printer 100, a user of the printer 100 may load paper into the space created by the rectangular or box-shaped point of sale display 200. In other words, the panels of the point of sale display 200 form an enclosure having an opening therein to allow placement of paper without interfering with an input paper feed path. The printer 100 may then operate as normal with the paper feeding into the printer from the input tray 110 with no interference from the point of sale display 200. In an embodiment of the invention, the point of sale display 200 may be attached to a front surface of the input tray 110 of the printer. In an embodiment of the invention, the back sheet or panel 210 of the point of sale display 200 may have an inner surface with an adhesive or a plurality of adhesives so as to adhere or fasten the inner surface of the back panel 210 of the point of sale display 200 to a back surface of the input tray 110 of the printer 100.

The adhesive or plurality of adhesives 285 have been placed to attach the point of sale display 200 to the input tray of the printer at a point on the input tray where the front panel 205 of the point of sale display 200 appears to be resting on a top surface of the printer. In other words, the adhesive or plurality of adhesives 285 connect the point of sale display 200 to the printer so that the front panel 205 of the point of sale display 200 is visible above a top surface of the printer 100. Thus, the indicia and features of the printer 100 are readable to an individual standing in front of the printer 100 or sitting when the printer 100 is at an eye level of the individual. The printed image assembly 250 and/or CD 270 is also prominently displayed to illustrate the image printing capability or the capability to print on a face of a recordable medium of the printer 100. This results in a point of sale display 200 with maximum visibility for a consumer who is interested in purchasing a printer 100 at a retail store or for a customer who is sitting at their desk in their office or home and looking at the printer 100.

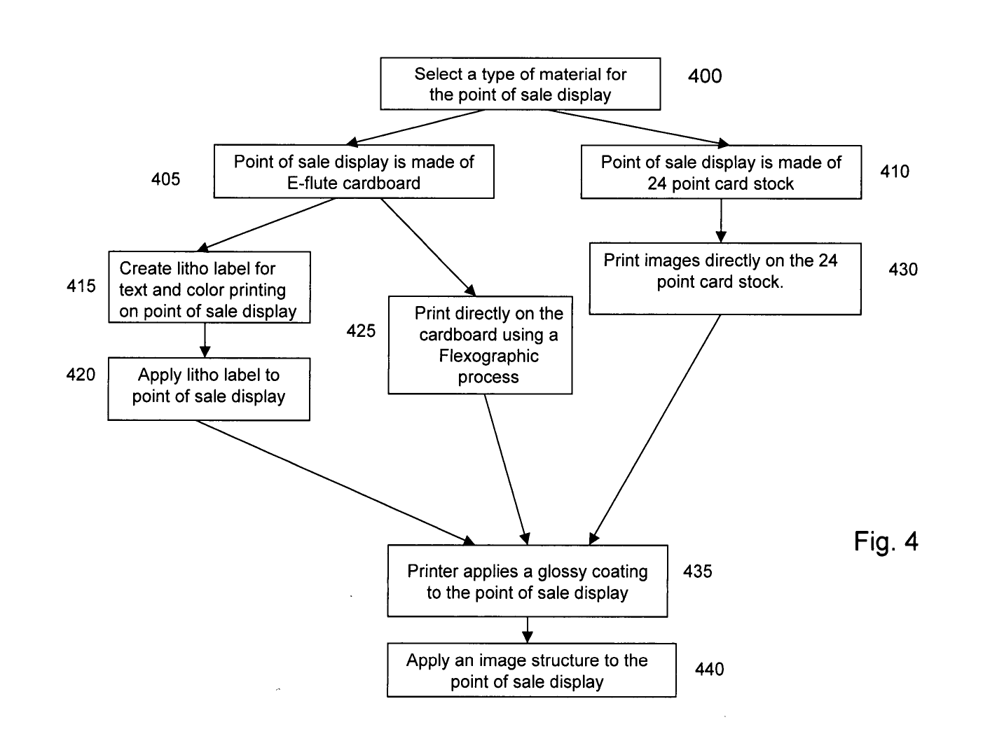

FIG. 4 illustrates a method of making a point of sale display according to an embodiment of the invention. A type of material is selected 400 to be utilized for the point of sale display. In an embodiment of the invention, the point of sale display may be constructed 405 of an E-flute cardboard. In an alternative embodiment of the invention, the point of sale display may be made 410 of 24 point card stock. In an embodiment of the invention, if the point of sale display is constructed of an E-flute cardboard, a litho label is created 415 and applied 420 directly to the E-flute cardboard. The application of the litho label on the E-flute cardboard produces high quality printing on the point of sale display. The litho label may be created for an outside surface of the front panel of the point of sale display. In an alternative embodiment of the invention, the litho label may be created for outside surfaces of a plurality of the panels of the point of sale display. In an alternative embodiment of their invention, a printer may print directly 425 onto the E-flute cardboard. In this embodiment of the invention, a Flexographic printing process may be utilized.

In an embodiment of the invention, if the point of sale display is constructed of 24 point card stock, a printer may print 430 images and text directly on the 24 point card stock. In an embodiment of the invention, offset lithography printing may be utilized to print directly on the 24 point card stock. In one embodiment of the invention, the 24 point card stock may be coated, which produces a more glossy finish. In an alternative embodiment of the invention, the 24 point card stock may be uncoated, which produces more of a matte finish. Under certain operating conditions, the printer may utilize water-based inks. Illustratively, the printer may utilize Epson's six color inks, e.g., cyan, magenta, yellow, black, Epson blue, and Epson silver. After printing on the point of sale display, a printer applies 435 a glossy coating to the point of sale display. Under certain operating conditions, the printer applies a protective varnish. Under other operating conditions, the printer applies an aqueous coating. After application of the glossy coating on the point of sale display, an image structure is adhered 440 to the point of sale display. The image structure may be a printed image assembly including a print of a photograph or a print of an image, or may be a recordable media having a printable surface.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A point of sale (POS) display for a printer, comprising:
a back panel, the back panel having an outside surface;
a pair of side panels, the pair of side panels being connected to the back panel; and
a front panel connected to the pair of side panels, the front panel including an outside surface having a printable area, the back panel, the pair of side panels, and the front panel having an opening therein adapted to be placed over an input tray of a printer without interfering with a paper feed path of the printer.

2. The POS display of claim 1, wherein the front panel further includes a printed image assembly attached to the outside surface of the front panel.

3. The POS display of claim 2, wherein an image of the printed image assembly was printed by a photo printer.

4. The POS display of claim 1, wherein the printable area includes indicia of features of the printer.

5. The POS display of claim 1, where the outside surface of the back panel includes at least one adhesive for adhering the POS display to an input tray of the printer.

6. The POS display of claim 1, wherein at least one of the pair of side panels includes a locking tab to provide stability for the POS display when the locking tab is locked.

7. The POS display of claim 6, wherein the locking tab folds against an inner surface of the at least one of the pair of side panels.

8. The POS display of claim 6, wherein the locking tab engages a slot in order to place the locking tab in an engaged position and the slot is located on a corner connecting the at least one of the pair of side panels to a back panel.

9. The POS display of claim 6, wherein the locking tab engages a slot in order to place the locking tab in an engaged position and the slot is located on a corner connecting at least one of the pair of side panels to a front panel.

10. The POS display of claim 1, wherein the POS display creates a rectangular box having a hollow interior.

11. The POS display of claim 1, wherein the back panel of the POS display has a greater height than the front panel of the POS display.

12. The POS display of claim 1, wherein the front panel, the back panel, and the pair of side panels are constructed of a single sheet of material which is foldable to form the POS display.

13. The POS display of claim 1, wherein the front panel further includes a recordable media having a printable surface and the recordable media is attached to the outside surface of the front panel.

14. The POS display of claim 13, wherein the recordable media has an image printed on the printable surface.

15. The POS display of claim 13, wherein the recordable media has text printed on the printable surface of the media.

16. The POS display of claim 13, wherein the front sheet, the pair of side sheets, and the back sheet create a box-shaped structure having a space in between to allow for paper to be placed inside the box-shaped structure.

17. The POS display of claim 13, wherein the back sheet of the POS display has a greater height than the front sheet of the POS display to allow the POS display to rest above a top surface of the printer.

18. A printer to advertise features of the printer, comprising:
an input tray to hold paper;
a printer body to draw paper into the printer from the input tray and to disperse ink on the paper when the paper is fed through the printer;
an output tray to receive the paper after the ink has been dispersed onto the paper; and
a point of sale (POS) display attached to the input tray of the printer, wherein the POS display includes a front panel having a printable surface and the POS display does not interfere with the drawing of paper into the printer.

19. The printer of claim 18, wherein the POS display further includes a printed image assembly attached to an outside surface of the front panel.

20. The printer of claim 18, wherein the POS display further includes a recordable media having a printable surface that is attached to an outside surface of the front panel.

21. The printer of claim 20, wherein the recordable disk has text or an image printed on the printable surface of the recordable media.

22. The printer of claim 18, wherein the point of sale display rests above a top surface of the printer.

23. The printer of claim 18, wherein the point of sale display is attached to a front surface of the input tray of the printer.

24. The printer of claim 18, wherein the point of sale display is attached to a back surface of the input tray of the printer.

25. A method of making a point of sale display, comprising:
selecting a material for construction of the point of sale display;
printing text and colors onto an outside surface of the point of sale display;
applying a glossy coating to the outside surface of the point of sale display; and
adhering an image structure to a front panel of the point of sale display.

26. The method of claim 25, wherein the material for the point of sale display is an E-flute cardboard and printing text and colors on the outside surface includes printing the text and colors on a lithographic label and adhering the lithographic label onto the outside surface of the point of sale display.

27. The method of claim 25, wherein the material for the point of sale display is an E-flute cardboard and printing text and colors on the outside surface includes printing the text and colors using a lithographic process.

28. The method of claim 25, wherein the material for the point of sale display is 24 point cardstock and the printing of the text and colors on the outside surface includes printing the text and colors using an offset lithography process.
